(19) United States
(12) Patent Application Publication
(10) Pub. No.: US 2021/0329369 A1
(43) Pub. Date: Oct. 21, 2021

(54) EARSET HAVING UTTERER VOICE RESTORATION FUNCTION

(71) Applicant: Orfeo SoundWorks Corporation, Seoul (KR)

(72) Inventor: Eundong KIM, Uiwang-si (KR)

(73) Assignee: Orfeo SoundWorks Corporation, Seoul (KR)

(21) Appl. No.: 17/292,445

(22) PCT Filed: Nov. 13, 2019
(86) PCT No.: PCT/KR2019/015462

§ 371 Date: May 9, 2021

(30) Foreign Application Priority Data
Nov. 14, 2018 (KR) 10-2018-0139686
Apr. 4, 2019 (KR) 10-2019-0039340
Nov. 13, 2019 (KR) 10-2019-0145033

(51) Int. Cl. H04R 1/10

(52) U.S. Cl. CPC H04R 1/1083; H04R 2460/11; H04R 1/1016

(57) ABSTRACT

Disclosed is an earset having an utterer voice restoration function. The earset having an utterer voice restoration function, according to the present invention, comprises: a case having a through hole; at least one speaker driver unit provided inside the case and having a back hole; and an in-ear microphone provided inside so as to be separated from the space in which the speaker driver unit is provided, wherein the speaker driver unit and the in-ear microphone are provided inside so as to be separated from the through hole by a separator, a microhole which allows the through hole to communicate with the back hole is formed in the separator, and a resonance space is formed between the microhole and the back hole.

### TECHNICAL FIELD

The present invention relates to a noise blocking headset, and more particularly, to an earset having an utterer voice restoration function that is capable of blocking external noise to improve qualities of speaker sounds and an utterer's voice.

### BACKGROUND ART

An earset as a typical in-ear earphone is a sound device inserted into the auricle and the ear canal to listen to sounds.

As the earset is inserted into the ear canal, an atmospheric pressure difference between the inside of the earset (human body pressure) and the outside of the earset (atmospheric pressure) is caused. In specific, an ear tip of the earset comes into close contact with the inner peripheral wall of the ear canal, and accordingly, the atmospheric pressure difference between the inside of the earset and the outside of the earset is made.

However, the atmospheric pressure difference has an influence on the vibration plate of a speaker driver unit. In specific, the vibration plate is inclined toward the outside of the earset. In this case, it is hard to output sounds, and further, the sounds are distorted.

So as to prevent the vibration plate from being inclined toward the outside of the earset, a back hole is formed on the rear surface of the speaker driver unit. The back hole communicates with the through hole formed on a case of the earset and thus serves to maintain the atmospheric pressures at the inside and outside of the earset to the same level as each other. Accordingly, the vibration plate can be vibrated at a regular position. In this case, the speaker driver unit is largely classified into a dynamic driver unit and a balanced armature driver unit.

Upon the operation of the vibration plate, on the other hand, artificial control may be performed so as to generate the atmospheric pressure difference, and to do this, the back hole may be covered with dampers having different mesh densities. Through the method, the speaker driver unit can be tuned.

However, the back hole formed on the rear surface of the speaker driver unit undesirably serves as a path through which external noise is introduced. So as to avoid the problem, if the back hole is blocked, the inclination of the vibration plate may occur, so that the earset cannot be used at the interior of an airplane or on a high mountain area. Further, if the back hole of the speaker driver unit is blocked, the vibration plate is suppressed from being vibrated to thus cause the sounds to be distorted.

Accordingly, there is a need for developing a new earset capable of preventing external noise from being introduced thereinto through the back hole formed on the rear surface of the speaker driver unit so that the qualities of speaker sounds and an utterer's voice can be improved.

### DISCLOSURE

### Technical Subject

Accordingly, the present invention has been made to solve the above-mentioned problems, and it is an object of the present invention to provide an earset having an utterer voice restoration function that is capable of allowing a microhole adapted to permit a through hole formed on a case to communicate with a back hole formed on a speaker driver unit to be formed on a separator for separating installation spaces and allowing a resonance space to be formed between the microhole and the back hole, thereby blocking external noise and improving the qualities of speaker sounds and the utterer's voice.

### Technical Solution

To accomplish the above-mentioned objects, according to the present invention, there is provided an earset having an utterer voice restoration function, including: a case having a through hole; at least one speaker driver unit provided inside the case and having a back hole; and an in-ear microphone provided inside the case in such a manner as to be separated from a space in which the speaker driver unit is provided,

wherein the speaker driver unit and the in-ear microphone are provided isolatedly from the through hole by means of a separator having a microhole adapted to allow the through hole to communicate with the back hole, and between the microhole and the back hole is formed a resonance space.

According to the present invention, the separator having the microhole is a resonance case adapted to cover the rear surface of the speaker driver unit on which the back hole is formed. Otherwise, the separator is an inner wall of the case or a printed circuit board (PCB).

According to the present invention, the microhole has a diameter of 100 μm or less or a diameter of 40 μm or less.

According to the present invention, the microhole has a diameter of 100 μm or more, and in this case, the microhole is covered with a mesh. The mesh has a density inversely proportional to a diameter of the microhole, and the density of the mesh 5 is determined desirably in the range of ±20% if the speaker driver unit is tuned.

According to the present invention, the earset further includes an out-ear microphone provided between the microhole and the through hole to receive the voice and external noise introduced through the through hole.

According to the present invention, the diameter of the microhole is set according to a thickness of the separator, and a ratio of the diameter of the microhole to the thickness of the separator is set to 1:1,000 or more.

### Advantageous Effects

According to the present invention, the earset having the utterer voice restoration function can basically block the external noise introduced into the back hole of the speaker driver unit, thereby allowing only the speaker sounds in which the external noise does not exist to be transmitted to the ear canal and allowing only the utterer's voice in which the external noise does not exist to be transmitted to the microphone (the in-ear microphone) to thus improve the qualities of the speaker sounds and the utterer's voice.

In addition, the earset having the utterer voice restoration function according to the present invention can form the resonance space of the speaker driver unit and maintain the atmospheric pressures at the inside and outside thereof to the same level as each other, so that the low-frequency sounds can be gently played to thus prevent the sounds from being distorted.

### BRIEF DESCRIPTION OF DRAWINGS

FIG. 1 is a concept view showing a noise blocking earset according to an embodiment of the present invention.

FIG. 2 is a concept view showing a noise blocking earset according to another embodiment of the present invention.

FIG. 3 is a concept view showing a noise blocking earset according to yet another embodiment of the present invention.

FIG. 4 is a concept view showing a noise blocking earset according to still another embodiment of the present invention.

FIG. 5 is a flowchart showing a process wherein the noise blocking earset according to the present invention is interlinked with a smartphone.

FIG. 6 is a flowchart showing a process wherein the noise blocking earset according to the present invention is interlinked with a specific device.

### BEST MODE FOR INVENTION

According to the present invention, an earset having an utterer voice restoration function includes: a case having a through hole; at least one speaker driver unit provided inside the case and having a back hole; and an in-ear microphone provided inside the case in such a manner as to be separated from a space in which the speaker driver unit is provided,

wherein the speaker driver unit and the in-ear microphone are separated from the through hole by means of a separator that has a microhole adapted to allow the through hole to communicate with the back hole, and between the microhole and the back hole is formed a resonance space.

### MODE FOR INVENTION

Hereinafter, the present invention will now be described in detail with reference to the attached drawings wherein the corresponding parts in the embodiments of the present invention are indicated by corresponding reference numerals.

In the description, when it is said that one portion is described as “includes” any component, one element further may include other components unless no specific description is suggested.

The terms “means”, “unit”, “module”, or “block” in the specification and claims indicate a unit for processing at least one function or operation, which may be implemented by hardware, software, or a combination thereof.

Before the explanation, first, kinds of holes as will be described below will be explained.

Firstly, a back hole BH represents a hole formed on the rear surface of a speaker driver unit.

Secondly, a microhole H represents a hole with a diameter of 100 μm or less, desirably, with a diameter of 40 μm or less.

Lastly, a through hole O represents a hole with a diameter of 100 μm or more.

Hereinafter, an explanation of an earset having an utterer voice restoration function (hereinafter, referred to as “noise blocking earset”) according to embodiments of the present invention will be given.

Before the description, the embodiments of the present invention will be explained in the order as follows.

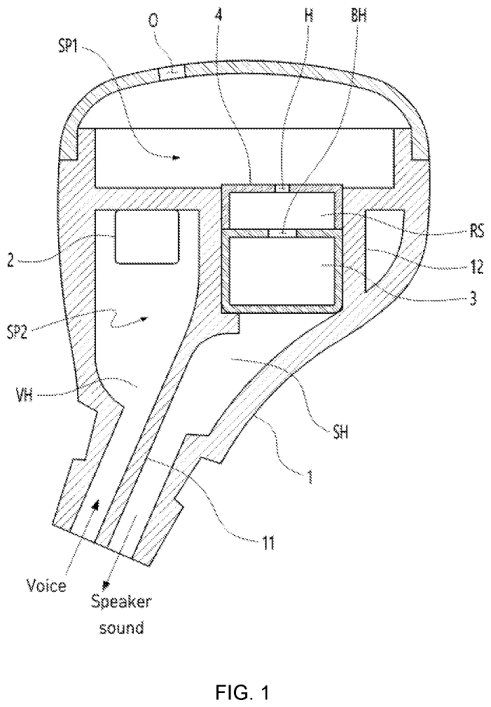

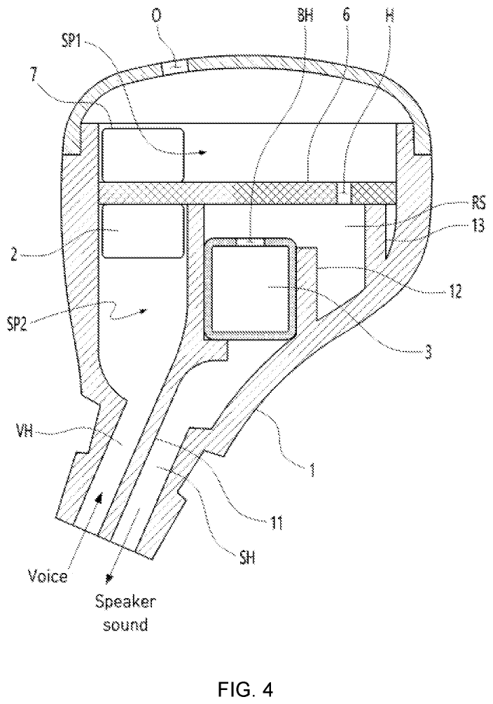

First, the embodiments in which a speaker driver unit and an in-ear microphone are built in the noise blocking earset according to the present invention will be explained (with reference to FIGS. 1 to 3). Next, the embodiment in which a speaker driver unit, an in-ear microphone, and an out-ear microphone are built in the noise blocking earset according to the present invention will be explained (with reference to FIG. 4).

However, the technology suggested in the present invention may be applied to an embodiment wherein the speaker driver unit and the out-ear microphone are built in the noise blocking earset according to the present invention and to an embodiment wherein only the speaker driver unit is built therein.

FIG. 1 is a concept view showing a noise blocking earset according to an embodiment of the present invention.

Referring to FIG. 1, the noise blocking earset according to one embodiment of the present invention includes a case 1 having a through hole O, an in-ear microphone 2 provided inside the case 1 to collect sounds received from the ear canal, and a speaker driver unit 3 provided inside the case 1 to output sounds to the ear canal.

In this case, further, a resonance case 4 is provided on the rear surface of the speaker driver unit 3, on which a back hole BH is formed.

Further, the resonance case 4 has a microhole H with a size capable of blocking external noise.

On the other hand, the microhole H may be formed at the position of the back hole BH of the speaker driver unit 3 by means of a laser, but in this case, a machining cost may be disadvantageously raised.

According to the present invention, as a result, the microhole H having a minimum diameter capable of blocking the external noise is formed on the resonance case 4. In specific, the microhole H has desirably a diameter of 100 μm or less, more desirably a diameter of 40 μm or less.

Also, the speaker driver unit 3 is selected from a dynamic driver unit and a balanced armature driver unit. If the dynamic driver unit as the speaker driver unit 3 is selected, the resonance case 4 is covered to a similar shape to the rear surface shape of the speaker driver unit 3 where the back hole BH is formed or to the same shape as the rear surface shape of the speaker driver unit 3. Generally, the resonance case 4 has a shape of a cylinder. On the other hand, if the balanced armature driver unit as the speaker driver unit 3 is selected, the resonance case 4 is covered to a similar shape to the rear surface shape of the speaker driver unit 3 where the back hole BH is formed or to the same shape as the rear surface shape of the speaker driver unit 3. Further, the contact surface between the rear surface of the speaker driver unit 3 and the resonance case 4 is sealed.

According to the present invention, the embodiment in which one in-ear microphone 2 and one speaker driver unit 3 are provided, but of course, two or more in-ear microphones 2 and two or more speaker driver units 3 may be provided.

According to the present invention, further, installation spaces SP1 and SP2 are separated through, for example, inner walls 11 and 12 and the resonance case 4, but they may be separated through the case, an inner wall separable from the case or coupled integrally with the case, or a printed circuit board (PCB). In specific, the installation spaces SP1 and SP2 can be separated through a separator having the case, the inner wall, or the PCB. If a resonance space RS is formed through the case, the inner wall, or the PCB, accordingly, the microhole H may be formed on the case, the inner wall, or the PCB.

If the inner wall as the separator is used, the resonance space RS is formed to a shape of a cylinder or polygon extended from the inner wall on which the microhole H is formed toward the speaker driver unit 3. In specific, in the case of the dynamic driver unit, the resonance space RS has a generally cylindrical shape, and in the case of the balanced armature driver unit, the resonance space RS has a shape of a generally rectangular post. As described above, of course, the resonance space RS desirably has a similar shape to the rear surface shape of the speaker driver unit 3 or has the same shape as that of the speaker driver unit 3. Further, the contact surface between the rear surface of the speaker driver unit 3 and the resonance case 4 is sealed.

If the PCB as the separator is used, further, the PCB is generally flat, and accordingly, the PCB is mounted to close a section cut at a given position of the case 1. When the given position of the case 1 is cut, in specific, the PCB perfectly closes the open region. Further, one surface of the PCB is located toward the installation space SP1, and the other surface is located toward the installation space SP2. In this case, the inner wall 11 through which the installation space SP2 is separated comes into contact with the PCB and is thus closed. Accordingly, the speaker driver unit 3 and the in-ear microphone 2 can be separatedly located around the inner wall 11.

The microhole H, which is formed in the noise blocking earset, through the various methods as mentioned above, serves to allow the back hole BH of the speaker driver unit 3 to communicate with the through hole O formed on the case 1.

In more specific, the technology in which the installation spaces SP1 and SP2 are separated from each other will be explained.

The interior of the case 1 is separated into the outer space SP1 and the inner space SP2 by means of the separator. According to the present invention, the inner walls 11 and 12 and the resonance case 4 constitute the separator. Of course, only the resonance case 4 can constitute the separator.

The inner space SP2 is separated through the first inner wall 11. Further, the in-ear microphone 2 is built in one side space separated through the first inner wall 11, and the speaker driver unit 3 is built in the other side space separated through the first inner wall 11.

The speaker driver unit 3 and the resonance case 4 are fitted to the space between the first inner wall 11 and the second inner wall 12 to spatially separate the outer space SP1 and a speaker sound path SH from each other. The in-ear microphone 2 is located on a microphone sound collecting path VH. That is, one side space where the in-ear microphone 2 is mounted forms the microphone sound collecting path VH, and the other side space where the speaker driver unit 3 is mounted forms the speaker sound path SH and the resonance space RS. Like this, one side space is used as the microphone sound collecting path VH. In this case, the microphone sound collecting path VH is formed on a nozzle portion of the space through the first inner wall 11 and the case 1, and the microphone sound collecting path VH is formed on a body center of the space through the first inner wall 11 and a separate voice guide inner wall (not shown). On the other hand, the other side space is used as the speaker sound path SH. In this case, the speaker sound path SH is formed on a nozzle portion of one side space through the first inner wall 11 and the case 1, and the speaker sound path SH or the resonance space RS is formed on a body center of one side space through the selection of the first inner wall 11, the second inner wall 12, and the case 1. Accordingly, the straightness of speaker playing sounds can be improved and low-frequency sounds can be gently played.

On the other hand, the diameter of the microhole H formed on the separator is desirably set according to the thickness of the separator. For example, a ratio of the diameter of the microhole H to the thickness of the separator is set to 1:100 to 1,000, desirably 1:1,000 or more. For example, if the thickness of the separator is 1 mm (1,000 μm), the diameter of the microhole H is set to the range of 1 to 10 μm.

Under the above-mentioned configuration, the noise blocking earset according to the present invention can block external noise by means of the microhole H formed on the separator such as the case, the inner wall, or the PCB, and can maintain atmospheric pressures at the inside and outside of the earset to the same level as each other. Further, the resonance space RS is formed between the microhole H and the rear surface of the speaker driver unit 3 on which the back hole BH is formed, thereby abundantly strengthening sounds.

In addition, the microhole H having a relatively small diameter is formed between the back hole BH and the through hole O, thereby serving as a low pass filter. When signal processed data through the microhole H is transmitted through a network, a high frequency range and a low frequency range are removed out of a bandwidth so as to reduce the quantity of data. In this case, the signal passing through the microhole H is in the low frequency range (below 100 Hz), and accordingly, the signal has no influence on the quantity of data.

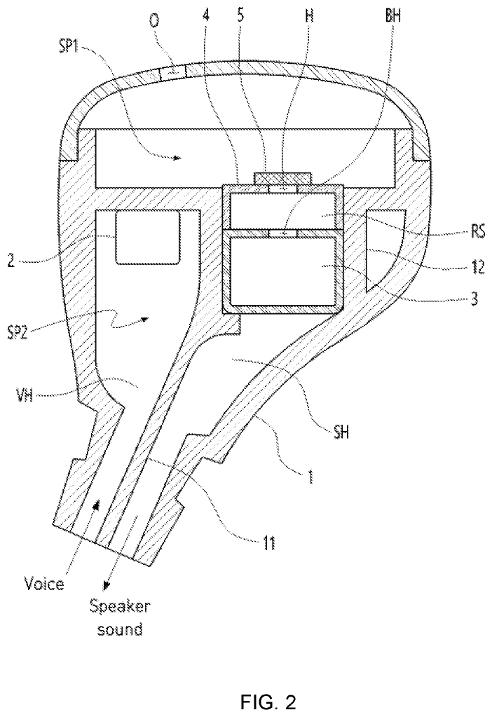

FIG. 2 is a concept view showing a noise blocking earset according to another embodiment of the present invention.

For the brevity of the description, on the other hand, an explanation of only the differences of the noise blocking earset of FIG. 2 from that of FIG. 1 will be given.

Referring to FIG. 2, the noise blocking earset according to another embodiment of the present invention is configured to have a through hole O formed on a resonance case 4 and to thus allow the through hole O to be covered with a mesh 5.

In specific, the through hole O with a larger diameter by 10 times than a hole with a minimum diameter (40 μm) capable of blocking external noise is formed, and next, the through hole O is covered with the mesh 5 having a density inversely proportional to the diameter of the through hole O. In this case, the density of the mesh 5 is determined in consideration of tuning, desirably in the range of ±20%. This is because the external noise is blocked out by means of the combination of the through hole O and the mesh 5. Through the interaction of the through hole O and the mesh 5, accordingly, the external noise can be blocked and the atmospheric pressures at the inside and outside of the earset can be maintained at the same level as each other.

If it is considered that the hole capable of blocking external noise has the diameter of about 40 μm, the through hole (microhole H) having a larger diameter (in the range of 0.4 to 0.6 mm) by 10 times than the hole is formed, and so as to add noise blocking capability to the through hole O that lacks the noise blocking capability as well as to provide sound tuning, the through hole O is covered with the mesh 5 having a high density of 300 to 600, so that the external noise can be prevented from being introduced into the ear canal and the in-ear microphone 2. That is, a desired technology for the in-ear microphone 2 can be embodied.

On the other hand, the embodiment wherein the through hole O is covered with the mesh 5 has been explained, but of course, the through hole O may be covered with a pad (not shown) on which a microhole is formed. Further, the mesh 5 may be covered on the microhole H of FIG. 1 for the purpose of tuning.

As shown in FIGS. 1 and 2, the earset according to the present invention is configured to locate the resonance case 4 on the rear surface of the speaker driver unit 3 so as to block external block, thereby improving the qualities of sounds and preventing the external noise from being introduced into the in-ear microphone 2. That is, the earset according to the present invention can prevent the external noise introduced through the back hole BH formed on the rear surface of the speaker driver unit 3 from being transmitted to the utterer's ear canal or prevent the external noise from being inputted to the in-ear microphone 2 along the speaker sound path SH and the microphone sound collecting path VH. Further, the earset according to the present invention is configured to allow the resonance space RS to be formed on the rear surface of the speaker driver unit 3 in such a manner as to communicate with the through hole O of the case 1, thereby improving back volumes and maintaining the atmospheric pressures at the inside and outside of the earset to the same levels as each other. Accordingly, the low frequency sounds of the speaker driver unit 3 can be strengthened to thus improve the qualities of sounds.

In specific, the earset according to the present invention is configured to allow the microhole H with the diameter of 100 μm, desirably about 40 μm that is capable of blocking external noise to be formed directly on the resonance case 4. Otherwise, the through hole O having the diameter of 100 μm or more is formed on the resonance case 4, and then, the through hole O is covered with the mesh 5 having the density inversely proportional to the diameter of the through hole O. Otherwise, the microhole H with the diameter of 100 μm, desirably about 40 μm that is capable of blocking external noise is formed on the resonance case 4, and for the purpose of tuning, next, the microhole H is covered with the mesh 5.

Through the resonance case 4 on which the microhole H is formed, accordingly, the atmospheric pressures at the inside and outside of the earset can be maintained to the same level as each other and the external noise introduced through the through hole O formed on the case 1 can be blocked.

Further, the resonance space RS is expanded by means of the resonance case 4, thereby increasing the back volumes, strengthening the low frequency sounds and improving the quality of sounds. Even if the sounds are reversely outputted through the back hole BH and the microhole H (the through hole O and the mesh 5, or the microhole H and the mesh 5) by means of the operation of the speaker driver unit 3, the sounds pass through the microhole H (the through hole O and the mesh 5, or the microhole H and the mesh 5) of the resonance case 4, so that only the low frequency sounds in the frequency of 100 Hz is outputted to thus block even the sounds leaking through the through hole O of the case 1.

On the other hand, the noise blocking earsets as suggested in FIGS. 1 and 8 each are configured to locate the resonance case 4 at the inside of the case 1, so that it requires a space for locating the resonance case 4 therein.

Accordingly, an explanation of a method for directly forming the microhole on the case, the inner wall, or the PCB that constitutes the separator will be given below.

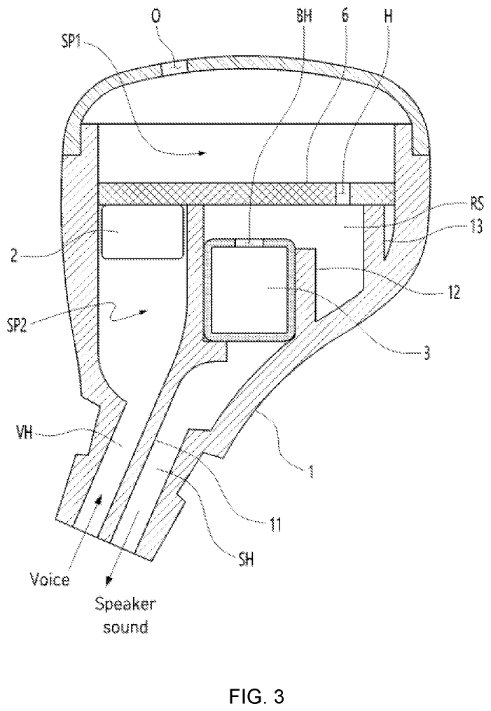

FIG. 3 is a concept view showing a noise blocking earset according to yet another embodiment of the present invention.

For the brevity of the description, on the other hand, an explanation of only the differences of the noise blocking earset of FIG. 3 from those of FIGS. 1 and 2 will be given.

Referring to FIG. 3, the noise blocking earset according to yet another embodiment of the present invention includes a case 1, a separator 6 for separating the space formed at the inside of the case 1 into an outer space SP1 and an inner space SP2 and having a microhole H formed thereon, a first inner wall for isolating the inner space SP2, an in-ear microphone 2 built in one side space separated through the first inner wall 1, a speaker driver unit 3 built in the other side space separated from the first inner wall 11, a second inner wall 12 for forming an installation space of the speaker driver unit 3, and a third inner wall 13 for forming a resonance space RS communicating with the rear surface of the speaker driver unit 3 on which a back hole BH is formed in such a manner as to be formed at a position allowing the resonance space RS to communicate with the microhole H.

The case, the inner wall, or a PCB may be used as the separator 6, and according to the present invention, the PCB is used as the separator 6. That is, the microhole H is formed on the PCB 6.

On the other hand, one side space is used as a microphone sound collecting path VH. In this case, the microphone sound collecting path VH is formed on a nozzle portion of one side space through the first inner wall 11 and the case 1, and the microphone sound collecting path VH is formed on a body center of one side space through the first inner wall 11 and a separate voice guide inner wall (not shown). On the other hand, the other side space is used as a speaker sound path SH. In this case, the speaker sound path SH is formed on a nozzle portion of the other side space through the first inner wall 11 and the case 1, and the speaker sound path SH or the resonance space RS is formed on a body center of the other side space through the selection of the first inner wall 11, the second inner wall 12, and the case 1. Accordingly, the straightness of speaker playing sounds can be improved and low-frequency sounds can be gently played. Further, the PCB 6 can be seated through the first inner wall 11 and the third inner wall 13.

On the other hand, a through hole O may be formed at a position of the microhole H. That is, if the through hole O having a diameter of 10 μm or more is formed at the position of the microhole H, the through hole O may be covered with a pad (not shown) on which a microhole is formed. Further, the embodiment in which the through hole O is covered with the pad has been explained, but the pad on which the microhole is formed may be directly mounted on the back hole BH of the speaker driver unit 3.

On the other hand, the pad is mounted on the outer space SP1 or the inner space SP2, and otherwise, the pad may be mounted directly on the PCB 6.

Various tuning may be possible according to the diameter size of the microhole formed on the pad. Further, if the pad is made in the form of a mesh, the tuning may be different according to the density of the mesh.

On the other hand, the speaker driver unit 3 is located on a speaker sound path SH, and in specific, the speaker driver unit 3 is located at the nozzle of the speaker sound path SH. Accordingly, the speaker sound path SH is short in front of the speaker driver unit 3, and the relatively large resonance space RS is formed behind the speaker driver unit 3.

FIG. 4 is a concept view showing a noise blocking earset according to still another embodiment of the present invention.

For the brevity of the description, on the other hand, an explanation of only the differences of the noise blocking earset of FIG. 4 from those of FIGS. 1 to 3 will be given.

Referring to FIG. 4, the noise blocking earset according to still another embodiment of the present invention further includes an out-ear microphone 7 located inside the case 1 to collect the sounds (voice and external noise) received from the outside thereof.

The out-ear microphone 7 is built in the outer space SP1. Further, the case 1 has a through hole O adapted to maintain an atmospheric pressure and to collect sounds.

According to the present invention, that is, the noise blocking earset is configured to have the case 1 with the through hole O formed thereon to allow the voice and external noise introduced through the through hole O to be inputted to the out-ear microphone 7, so that the out-ear microphone 7 checks whether an utterer's voice is produced or makes use of the voice inputted to the in-ear microphone 2 with reference to the utterer's voice inputted thereto as a reference signal for restoring to the utterer's original voice thereof. On the other hand, if the external noise with which the utterer's voice is mixed is greater than a set value, for example, 40 db, driving of the out-ear microphone 7 is stopped, and only the in-ear microphone is driven, thereby desirably restoring to the utterer's original voice.

According to the noise blocking earsets as suggested in FIGS. 1 to 4, further, the embodiments in which the microhole H or the through hole O and the mesh 5 is (are) formed on the resonance case 4 have been explained, but of course, the microhole H and the mesh 5 may be formed on the resonance case 4. So as to achieve double noise blocking and tuning of the speaker driver unit 3, that is, the microhole H and the mesh 5 may be formed on the resonance case 4. As the resonance space RS is formed, accordingly, the vibration plate of the speaker driver unit 3 can be prevented from being inclined toward the outside of the earset. Therefore, the through hole O formed on the case 1 may be replaced with the microhole H. Accordingly, primary noise blocking is obtained through the microhole H formed on the case 1, and secondary noise blocking is obtained through the selection of the microhole H formed on the resonance case 4, the combination of the through hole O and the mesh 5, or the selective combination of the microhole H and the mesh 5.

Hereinafter, an explanation of an operation process of the noise blocking earset according to the present invention will be given.

First, it is assumed that the noise blocking earset is paired to a smartphone, and so as to perform the pairing, wire/wireless communication, desirably near field communication (NFC) such as Wi-Fi, Bluetooth, and so on is used. According to the present invention, an explanation of the operating process of the noise blocking earset paired to the smartphone through Bluetooth will be given.

According to the present invention, on the other hand, transmitting and receiving processes between the noise blocking earset and the smartphone in the state where the noise blocking earset is paired to the smartphone will be described, but the functions of the smartphone may be provided in the noise blocking earset itself, so that the noise blocking earset itself can perform all of the transmitting and receiving processes.

According to the present invention, further, a process of receiving the sound signal executed in the smartphone, performing the conversion into a state for calling, and transmitting the utterer's voice signal will be described.

According to the present invention, in addition, an embodiment in which the noise blocking earset (Bluetooth earset for calling) is configured to have the in-ear microphone 2 and the speaker driver unit 3 built in the case 1 and to have the resonance case 4 applied to the speaker driver unit 3 will be explained.

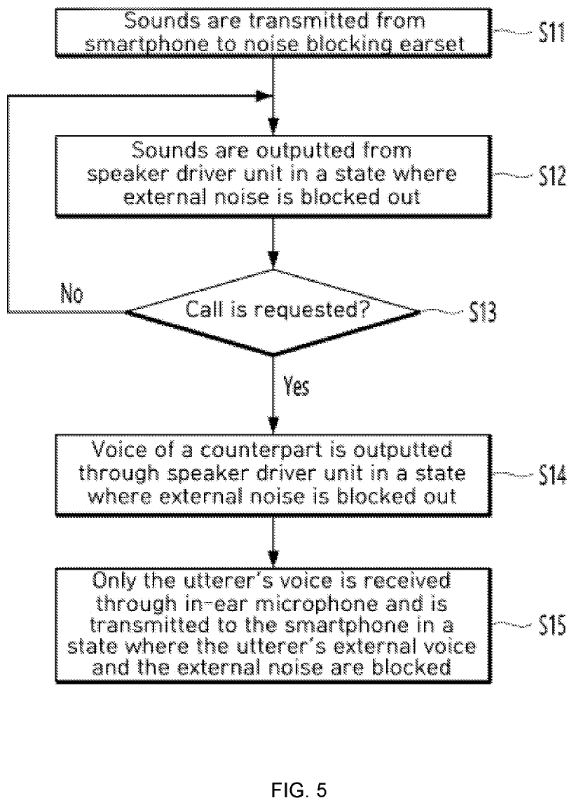

FIG. 5 is a flowchart showing a process wherein the noise blocking earset according to the present invention is interlinked with a smartphone.

Referring to FIG. 5, if sounds are included in the file executed in the smartphone, the sounds are transmitted from the smartphone to the noise blocking earset (at step S11).

Next, the sounds are processed in the noise blocking earset and are then outputted through the speaker driver unit 3 (at step S12). In this case, even though external noise is introduced through the through hole O of the case 1 into the noise blocking earset, the external noise is blocked out by means of the microhole H of the resonance case 4 or the through hole and the mesh 5 of the resonance case 4, so that speaker sounds in which the external noise is not included can be outputted.

If a call is requested during the output of the sounds through the speaker driver unit 3 (at step S13), the noise blocking earset is converted into a call state according to a user's control, and accordingly, the voice signal of a counterpart is processed and is then outputted through the speaker driver unit 3 (at step S14). Like the step S12, in this case, the speaker sounds in which the external noise is not included can be outputted even if the external noise is introduced into the noise blocking earset.

If an utterer's voice is produced, on the other hand, the utterer's voice, which is transmitted to the ear canal through the Eustachian tube, is received through the in-ear microphone 2, and the utterer's voice signal is transmitted to the smartphone and is then transferred to the counterpart (at step S15).

In this case, the utterer's voice produced through his or her mouth and the external noise are introduced into the noise blocking earset through the through hole O of the case 1, but they are blocked by means of the microhole H of the resonance case 4 or the through hole O and the mesh 5 of the resonance case 4, so that only the utterer's voice transferred to the ear canal through the Eustachian tube is introduced into the in-ear microphone 2 and is processed to the signal, thereby allowing the utterer's original sound in which the external noise is not included to be easily restorable.

If the call is finished, further, the file stopped may be kept to a standby state or be executed again.

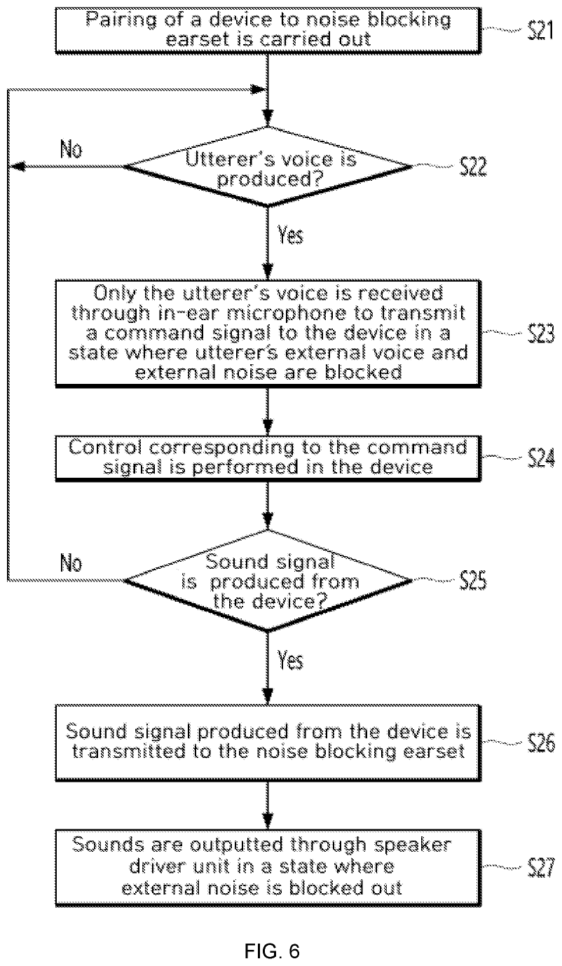

FIG. 6 is a flowchart showing a process wherein the noise blocking earset according to the present invention is interlinked with a specific device.

Referring to FIG. 6, pairing of a device to be controlled to the noise blocking earset is first carried out (at step S21).

If the pairing is finished, it is determined whether an utterer's voice is produced (at step S22), and if the utterer's voice is produced, a command signal corresponding to the utterer's voice is produced.

In this case, the utterer's voice produced through his or her mouth and the external noise are introduced into the noise blocking earset through the through hole O of the case 1, but they are blocked by means of the microhole H of the resonance case 4 or the through hole O and the mesh 5 of the resonance case 4, so that only the utterer's voice transferred to the ear canal through the Eustachian tube is introduced into the in-ear microphone 2 and is processed to the signal, thereby allowing the utterer's original sounds in which the external noise is not included to be easily restorable. Accordingly, the command signal can be accurately produced.

Next, the command signal is transmitted from the noise blocking earset to the paired device (at step S23).

After that, the control corresponding to the command signal is performed in the device (at step S24).

If a sound signal is produced through the operation of the device (at step S25), further, the sound signal is transmitted to the noise blocking earset (at step S26) and is then outputted through the speaker driver unit 3 (at step S27). In this case, even though external noise is introduced through the through hole O of the case 1 into the noise blocking earset, the external noise is blocked out by means of the microhole H of the resonance case 4 or the through hole and the mesh 5 of the resonance case 4, so that speaker sounds in which the external noise is not included can be outputted.

If the utterer's voice is produced during the output of the sounds through the speaker driver unit 3, further, the utterer's voice is received through the in-ear microphone 2, and if a command signal corresponding to the utterer's voice is produced, the utterer's command signal is transmitted to the corresponding device, so that the control corresponding to the command signal can be performed.

On the other hand, the embodiments as shown in FIGS. 5 and 6 in which the in-ear microphone 2 and the speaker driver unit 3 are built in the noise blocking earset have been explained, but in the case where the noise blocking earset having the out-ear microphone 7 is adopted, if the utterer's voice is produced during the output of the sounds through the speaker driver unit 3, it is determined whether the utterer talks through the out-ear microphone 7, so that the volume of the sounds outputted at present through the speaker driver unit 3 can be reduced. This is to accurately receive the utterer's voice through the in-ear microphone 2. On the other hand, if the external noise with which the utterer's voice is mixed is greater than a set value, for example, 40 db, driving of the out-ear microphone 7 is stopped, and only the in-ear microphone is driven, thereby desirably restoring to the utterer's original voice. In this case, desirably, the restoration to the utterer's original voice is carried out through the user's voice sample in advance stored.

As described above, the technical scope of the present invention has been described with reference to the particular illustrative embodiments.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings. It is therefore intended that the scope of the invention be limited not by this detailed description, but rather by the claims appended hereto.

### INDUSTRIAL APPLICABILITY

The present invention can be usefully used in a place where noise is seriously generated.

1. An earset having an utterer voice restoration function, comprising:
a case having a through hole;
at least one speaker driver unit provided inside the case and having a back hole; and
an in-ear microphone provided inside the case in such a manner as to be separated from a space in which the speaker driver unit is provided,
wherein the speaker driver unit and the in-ear microphone are provided isolatedly from the through hole by means of a separator having a microhole adapted to allow the through hole to communicate with the back hole, and between the microhole and the back hole is formed a resonance space.

2. The earset according to claim 1, wherein the separator having the microhole is a resonance case adapted to cover the rear surface of the speaker driver unit on which the back hole is formed.

3. The earset according to claim 1, wherein the separator is an inner wall of the case.

4. The earset according to claim 1, wherein the separator is a printed circuit board (PCB).

5. The earset according to claim 1, wherein the microhole has a diameter of 100 μm or less or a diameter of 40 μm or less.

6. The earset according to claim 1, wherein the microhole has a diameter of 100 μm or more.

7. The earset according to claim 6, wherein the microhole is covered with a mesh.

8. The earset according to claim 7, wherein the mesh has a density inversely proportional to a diameter of the microhole.

9. The earset according to claim 8, wherein the density of the mesh 5 is determined in the range of ±20% if the speaker driver unit is tuned.

10. The earset according to claim 1, further comprising an out-ear microphone provided between the microhole and the through hole to receive the voice and external noise introduced through the through hole.

11. The earset according to claim 1, wherein the diameter of the microhole is set according to a thickness of the separator.

12. The earset according to claim 11, wherein a ratio of the diameter of the microhole to the thickness of the separator is set to 1:1,000 or more.
